(19) United States
(12) Patent Application Publication
(10) Pub. No.: US 2016/0228991 A1
(43) Pub. Date: Aug. 11, 2016

(54) ACOUSTIC MANIPULATION AND LASER PROCESSING OF PARTICLES FOR REPAIR AND MANUFACTURE OF METALLIC COMPONENTS

(71) Applicant: Siemens Energy, Inc., Orlando, FL (US)

(72) Inventors: Daniel J. Ryan, Oviedo, FL (US); Ahmed Kamel, Orlando, FL (US); Gerald J. Bruck, Titusville, FL (US)

(21) Appl. No.: 14/997,554

(22) Filed: Jan. 17, 2016

Related U.S. Application Data
(60) Provisional application No. 62/112,398, filed on Feb. 5, 2015.

(51) Int. Cl. B23K 26/342; B23K 26/00; B23K 25/00

(52) U.S. Cl. CPC B23K 26/342; B23K 25/005; B23K 26/0093; B33Y 10/00

(57) ABSTRACT

A disclosed method includes the steps of generating at least one ultrasonic standing wave (6′) between at least one set of mutually-opposed ultrasonic transducers (20A, 20B), dispensing metal-containing particles (22, 24, 26) into a node (14) located within the ultrasonic standing wave such that the particles are trapped in the node, positioning a surface of a substrate (160) proximate to the node, melting the particles with an energy beam to form a melt pool (170) in contact with the surface, and allowing the melt pool to cool and solidify into a metal deposit (176) bound to the surface. Apparatuses for carrying out such methods are also disclosed.

This application claims benefit of the 5 Feb. 2015 filing date of U.S. provisional patent application No. 62/112,398.

### FIELD OF THE INVENTION

This invention relates generally to the field of materials technology, and specifically to laser processing of particles being manipulated with acoustic energy, and more specifically to methods and apparatuses that enable the fabrication and repair of multi-material components through laser processing of metallic and ceramic particles being manipulated with acoustic energy.

### BACKGROUND OF THE INVENTION

Selective laser additive manufacturing includes selective laser melting (SLM) and selective laser sintering (SLS) of powder beds to build a component layer by layer to achieve a net shape or a near net shape. In such processes a powder bed of the component final material or precursor material is deposited on a working surface. Laser energy is selectively directed onto the powder bed following a cross-sectional area shape of the component, thus creating a layer or slice of the component, which then becomes a new working surface for the next layer. The powder bed is conventionally spread over the working surface in a first step, and then a laser defines or “paints” the component sectional area on the bed in the following step. The component is then indexed vertically down with respect to the processing plane in a third step. The three steps are repeated to build a part in a layer-like fashion.

Use of mixed bed approaches does not allow for selective placement of different materials to form integrated systems containing multiple materials. Such integrated systems may include, for example, an inner superalloy substrate coated with a diffusion bonded MCrAlY coating which is further bonded to an outer ceramic thermal barrier coating (TBC). Selective placement of different materials would be necessary in order to employ laser additive manufacturing (LAM) techniques to efficiently produce multi-material components containing integrated systems such as the gas turbine airfoil 300 illustrated in FIG. 17.

FIG. 17 is a cross-sectional view of an exemplary gas turbine airfoil 300 containing a leading edge 302, a trailing edge 304, a pressure side 306, a suction side 308, a metal substrate 310, cooling channels 312, partition walls 314, turbulators 316, film cooling exit holes 318, cooling pins 320, and trailing edge exit holes 322. In this example, whereas the metal substrate 310, partition walls 314, turbulators 316 and cooling pins 320 are fabricated of a superalloy material, the exterior surfaces of the airfoil substrate 310 are coated with a porous ceramic thermal barrier coating 324. A metallic bond coat 326 such as an MCrAlY may also be applied between the superalloy substrate 310 and the thermal barrier coating 324 to enhance bonding between the superalloy and ceramic layers and to further protect the superalloy material from external oxidants.

The use of LAM techniques to produce a multi-material component such as the airfoil of FIG. 17 would require not only the selective placement of different materials, but it would also require an ability to selectively apply different processing conditions (i.e., placement and intensity of laser heating) to these different components. This is because selective melting of a superalloy powder to form the metal substrate 310 would generally require different heating conditions than selective sintering of a ceramic powder to form the thermal barrier coating 324. Another serious complication arises from the need to protect the superalloy powder and resulting metal substrate 310 from reacting with atmospheric oxidants such as oxygen and nitrogen. Especially for a large airfoil 300, the use of LAM techniques could also require an ability to perform SLM and SLS under atmospheric conditions without jeopardizing the chemical and/or physical properties of the resulting component.

Although selective powder placement can be achieved using a plurality of nozzles adapted to deliver powder sprays to a focal point, such techniques using gas-fed filler powder often experience a high percentage of waste of valuable filler material due to scattering of the powder during processing. Powder scattering can also occur when using open powder beds due to pressure generated by plasmas that form during laser processing.

### BRIEF DESCRIPTION OF THE DRAWINGS

The invention is explained in the following description in view of the drawings that show:

FIG. 1 illustrates the use of mutually-opposed ultrasonic transducers to generate an ultrasonic standing wave in which particles can be trapped and steered to nodes separated by a fixed distance;

FIG. 2 illustrates the use of two orthogonal sets of mutually-opposed ultrasonic phased-array transducers to generate overlapping ultrasonic standing waves in which particles can be trapped and steered in a three-dimensional space defined in part by the arrangement of the transducers;

FIGS. 3A and 3B illustrate one embodiment of how a separation distance of particles trapped within an ultrasonic standing wave can be altered by simultaneously adjusting the separation distance of mutually-opposed ultrasonic transducers and the wavelength of an ultrasonic standing wave generated between the transducers;

FIG. 4 illustrates one embodiment of an apparatus for laser processing of particles being held and manipulated with acoustic energy in which two orthogonal sets of mutually-opposed ultrasonic transducers are situated horizontally;

FIG. 5 illustrates one embodiment of an apparatus for laser processing of particles being held and manipulated with acoustic energy in which two orthogonal sets of mutually-opposed ultrasonic transducers are situated vertically;

FIG. 6 is a schematic diagram of one embodiment of a method for laser processing of particles being held and manipulated with acoustic energy;

FIGS. 7A-7D illustrate embodiments of a method for laser processing of particles being held and manipulated with acoustic energy;

FIGS. 8A-8C illustrate embodiments of a method for removing a slag layer covering a deposited metal layer;

FIG. 9 illustrates one embodiment of a method for laser processing of different sets of particles being independently held and manipulated with acoustic energy to form a multi-material deposit;

FIG. 10 illustrates a sectional view of one embodiment of a composite particle containing a metallic outer layer surrounding an inner flux-containing core;

FIG. 11 illustrates a sectional view of one embodiment of a composite particle containing a metal alloy and a flux composition and having a glass-like, crystalline, or semi-crystalline structure;

FIGS. 12A and 12B illustrate the use of acoustic energy to separate particles having different sizes and different densities;

FIG. 13 illustrates the use of an ultrasonic phased-array transducer to generate and move a single focal point;

FIG. 14 illustrates one embodiment of a method for separating particles on a flat surface using acoustic energy;

FIG. 15A illustrates the use of acoustic energy to selectively excite a particle having a natural frequency fₙ^{A},

FIG. 15B illustrates the use of acoustic energy to selectively excite particles having a natural frequency fₙ^{A}, causing a selective fluidization of particles in a mixed bed;

FIG. 16 illustrates an apparatus capable of both selective particle excitation and particle trapping and steering, according to one embodiment; and

FIG. 17 illustrates a sectional view of a gas turbine airfoil.

### DETAILED DESCRIPTION OF THE INVENTION

The present inventors recognized that a need exists for methods and apparatuses allowing the manufacture and repair of intricate multi-material components in an automated (additive) fashion through the efficient use of powdered materials. Such methods and apparatuses would ideally enable selective handling, placement, and processing of different powdered materials—while at the same time minimizing the inefficient use of expensive materials that can result from scattering of powdered materials and degradation of sensitive metals through exposure to air. Ideal methods and apparatuses would also avoid the use of powder beds in which an excess amount of expensive and/or air-sensitive powder is used to envelop the working surface.

The present inventors propose solving the problems described above by using acoustic trapping and manipulation (steering) of particles to enable the efficient and automated repair and fabrication of three-dimensional components through methods such as selective laser additive manufacturing.

It is known that particles and other acoustic discontinuities are subjected to certain forces when exposed to ultrasonic energy. These so-called acoustic forces are generally larger in an ultrasonic standing wave (USW) than in a progressive wave. Furthermore, the physical location of particles may be predictably altered by exposing the particles to an ultrasonic standing wave having a defined resonant frequency.

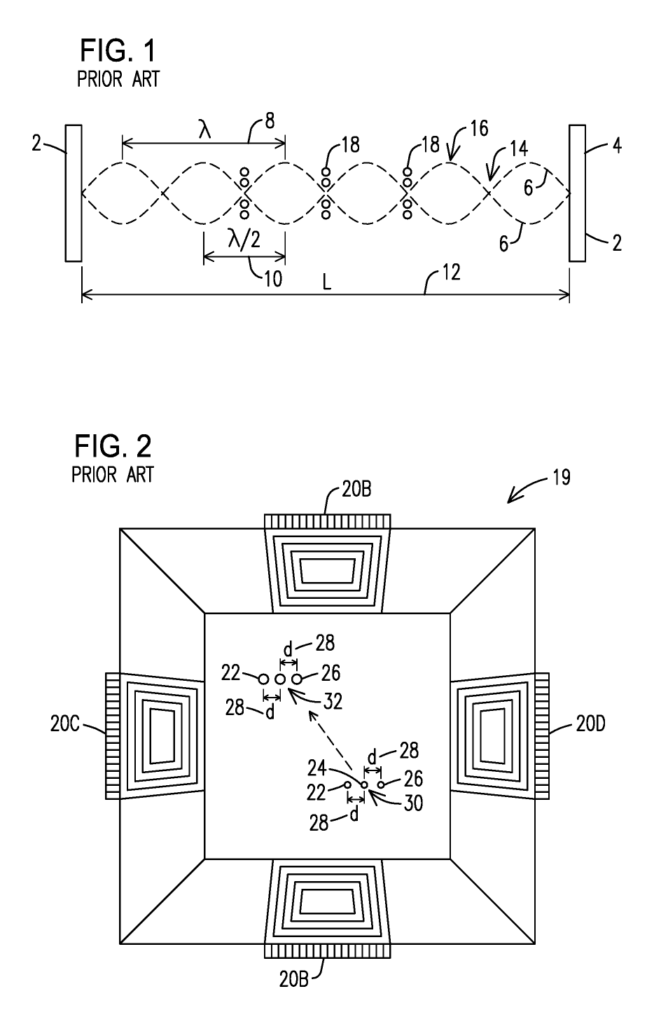

FIG. 1 illustrates a system in which particles 18 within a fluid are bounded by two mutually-opposed ultrasonic transducers 2, or by a transducer 2 and a mutually-opposed reflector 4. When the transducer 2 (or set of transducers) is driven so as to excite a resonance frequency of the cavity, a standing wave 6 can be created in the cavity with associated pressure maxima and minima. In order to match the resonance frequency of the cavity, the separation length (L) 12 between the mutually-opposed transducers 2 (or between the transducer 2 and the reflector 4) must equal a whole number multiple (N) of either a full wavelength (λ) 8 or half-a-wavelength (λ/2) 10, as expressed in Equation (1):

$$L = N \times ( \frac{λ}{2} ) \qquad ( 10 )$$

where ‘N’ represents a whole number greater than zero.

Particles 18 exposed to the standing wave 6 will generally be transported towards pressure nodes 14 within the field by axial forces. Theory predicts that particles will move towards either the nodes 18 or the antinodes 16 of the standing wave depending upon the relative density factor (ratio of the fluid and particle densities), see, e.g., Hill, M. et al., “Ultrasonic Particle Manipulation,” Microfluidic Technologies for Miniaturized Analysis Systems (2007), Chapter 9, pp. 357-83. When the ratio of the particle density to the fluid density is less than 0.4 (and the particle is incompressible) the acoustic force will act towards the pressure antinodes 16. For density ratios above 0.4, which will be the case for real near-rigid particles, the acoustic radiation force will act towards the pressure node of the standing wave.

This basic concept has recently been improved to allow acoustic trapping and manipulation of particles capable of being levitated in a three dimensional space. FIG. 2 depicts an ultrasonic levitation apparatus 19 employing two sets of mutually-opposed phased-array ultrasonic transducers 20A-20D, which was recently described by Ochiai, Y. et al., PLOS One, 2014, 9(5), pp. 1-5, the entire contents of which are incorporated herein by reference. This manipulation system 19 includes two mutually-opposed arrays 20A-20B and 20C-20D that are used to generate standing waves having a common focal point. The position of the focal point may then be digitally controlled with a resolution of 1/16 of the wavelength to alter the position of particles trapped in standing wave nodes to allow manipulation of the particles within the three-dimensional space.

For example, as illustrated in FIG. 2, three separate sets of levitated particles 22, 24 and 26 having a fixed separation distance 28 may be moved from one focal point 30 to another focal point 32 in the three-dimensional space by digitally retuning the phase-array transducers 20A-20D. Importantly, because the wavelengths (and frequencies) of the perpendicular standing waves are fixed, the separation distance 28 for the particles 22, 24 and 26 remains constant from one focal point 30 to another 32.

Embodiments of the present disclosure, on the other hand, will allow manipulation of not only the focal point of levitated particles in a three-dimensional space, but will also allow adjustment of the separation distance 28 between the different sets of particles 22, 24 and 26. Such an ability to control the separation distance 28 can be important in some embodiments involving the selective placement and processing of different materials (e.g., metal versus ceramic materials) forming different portions of intricate three-dimensional components. Furthermore, embodiments of the present disclosure will enable an ability to reliably levitate and manipulate metal-containing particles which are generally considered to be difficult, if not impossible, to levitate using acoustic energy.

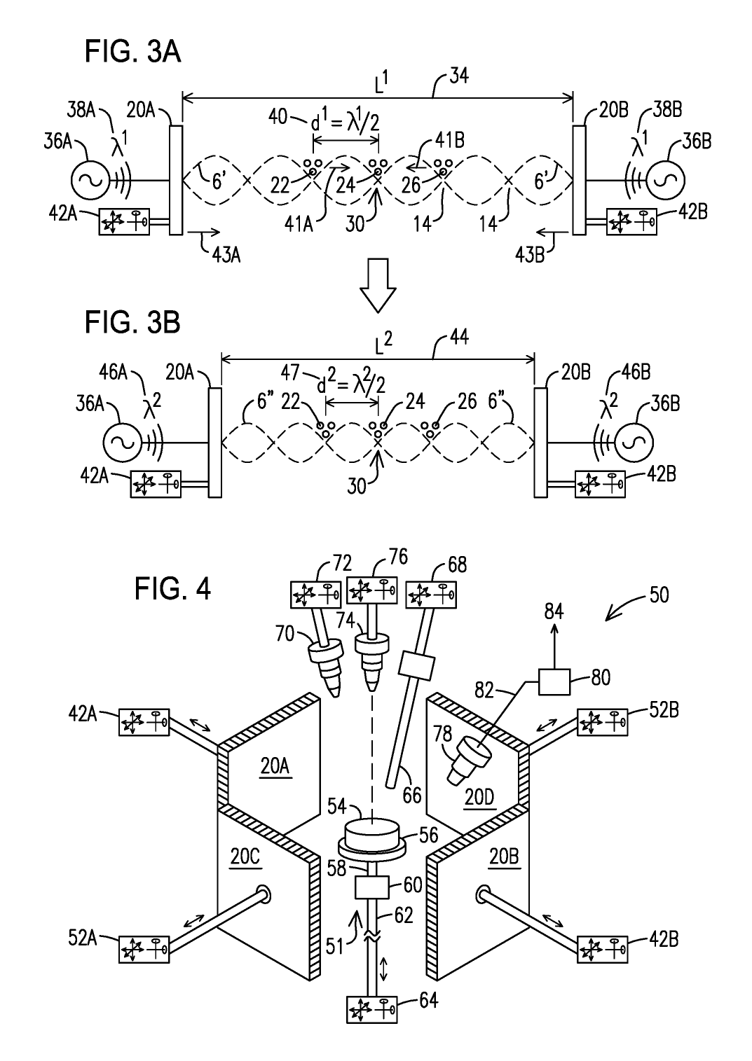

FIGS. 3A and 3B illustrate one embodiment enabling the separation distance 40 between different sets particles 22, 24 and 26 trapped in nodes of an ultrasonic standing wave to be altered. FIG. 3A depicts an initial state in which the three sets of particles 22, 24 and 26 are trapped/levitated within different nodes 14 of an initial ultrasonic standing wave 6′ generated from two mutually-opposed transducers 20A and 20B. Unlike the levitation system 19 of FIG. 2, the transducers 20A and 20B of FIG. 3A are moveable transducers connected to a pair of transducer movement actuators 42A and 42B. The initial separation distance (d¹) 40 of the levitated particles 22, 24 and 26 may be altered by simultaneously reducing both the separation distance (L¹) 34 and wavelength 38A and 38B of the ultrasound emitted from the transducers 20A and 20B—such that at any given moment during the transition the separation distance 40 satisfies Equation (1) above. Wavelength (and frequency) modulation is accomplished by simultaneously controlling the ultrasound generators 36A and 36B to maintain a standing wave within the transitioning separation distance (L¹) 34.

FIG. 3B depicts the final state in the which the three sets of particles 22, 24 and 26 are still trapped/levitated within the corresponding nodes, but because the separation distance (L²) 44 and the wavelengths 46A and 46B are lower than the corresponding distance (L¹) 34 and frequencies 38A, 38B in FIG. 3A, the final particle separation distance (d²) 47 is now smaller than the initial particle separation distance (d¹) 40. In the non-limiting illustration of FIGS. 3A and 3B, the position of the transducers 20A and 20B is altered to maintain a common focal point 30 such that the set of particles 24 maintains its original position while the sets 22 and 26 move inward 41A, 41B to reduce the separation distance. In other embodiments an initial focal point may be altered such that the separation distance and position of all levitated particles may be changed.

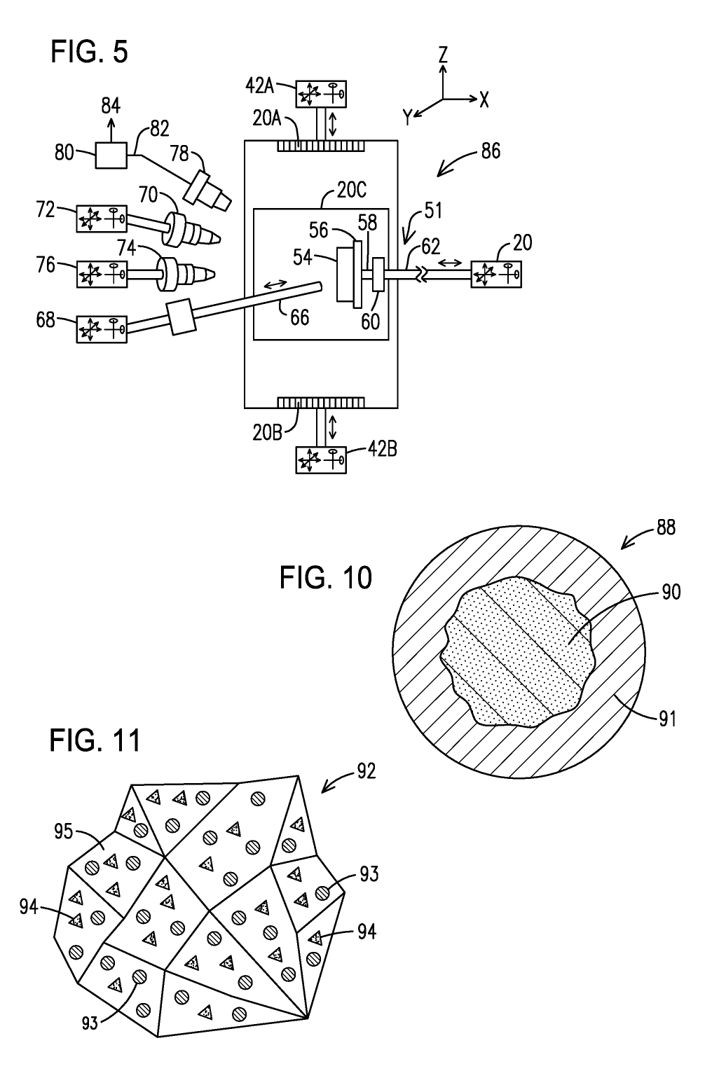

FIG. 4 illustrates one embodiment of an acoustic levitation laser processing apparatus 50 having a horizontal orientation. FIG. 5 illustrates a related embodiment of an acoustic levitation laser processing apparatus 86 having a vertical orientation.

The non-limiting apparatus 50 of FIG. 4 includes two sets of mutually-opposed phased-array ultrasonic transducers 20A-20B and 20C-20D arranged in a horizontally-oriented square-shaped work area further containing a moveable support structure 51 comprising a working surface 54 attached to a support plate 56 connected to a platen 58 that is in acoustic communication with an additional transducer 60. In the non-limiting embodiment of FIG. 4 the transducer 60 is connected to a component movement actuator 64 via a moveable piston 62. The ultrasonic phased-array transducers 20A, 20B, 20C and 20D are each connected to independently-operable transducer movement actuators 42A, 42B, 52A and 52B respectively which, as explained above, allow respective distances (L) between the mutually-opposed transducers to be adjusted. Although not shown in FIG. 4, each ultrasonic phase-array transducer 20A, 20B, 20C and 20D is further controlled by an ultrasonic generator (e.g., 36A or 36B in FIG. 3A) allowing synchronized modulation of standing wave wavelengths (frequencies).

The size, dimensions, placement and number of ultrasonic transducers are not confined to the illustrations in FIGS. 4 and 5. In other embodiments these parameters may be altered significantly. In some embodiments, for example, the ultrasonic phased array transducers may be curved to form concave transducers, or may be arranged into a continuously circular or spherical array that surrounds the working object being fabricated or repaired. Acoustic transducers of the present disclosure may be fabricated using materials and techniques well known in the art for producing acoustic energy.

The apparatus 50 of FIG. 4 also contains additional components enabling particle handling and laser processing. These components include a particle handling device 66 adapted to dispense particles into any node located within an ultrasonic standing wave generated between the mutually-opposed transducers, and/or to withdraw particles from any node located within a standing wave. In some embodiments the apparatus may include at least one particle delivery device 66 and optionally at least one particle withdrawal device 66. In some embodiments the particle delivery device 66 may be in the form of an acoustically-reflective or non-reflective pipette device capable of precisely dispensing particles into individual nodes at a sufficiently low velocity to allow capture (trapping) and levitation of the particles within the nodes. In some embodiments the particle withdrawal device 66 may be in the form of an acoustically-reflective or non-reflective pipette device capable of precisely withdrawing particles from individual nodes at sufficiently low velocity to allow selective withdrawal of sets of levitated particles without disrupting particles trapped in nearby nodes. In some embodiments the particle withdrawal device 66 precisely withdraws particles by drawing a slight vacuum on levitated particles located in a particular node.

The particle handling device 66 is also adapted to be independently moveable such that particles may be delivered and/or withdrawn to or from any location within the work area of the apparatus 50. To enable movement the particle handling device 66 is attached to a handling device movement actuator 68.

The non-limiting apparatus 50 of FIG. 4 also contains a first and second energy beam source 70, 74 adapted to be independently movable such that a trajectory of an energy beam transmitted by the energy beam source can be directed to a target surface on the working surface 54. The term “energy beam” is used herein in a general sense to describe a narrow, propagating stream of particles or packets of energy. An energy beam as used in this disclosure may include a light beam, a laser beam, a particle beam, a charged-particle beam, a molecular beam, etc., which upon contact with a material imparts kinetic (thermal) energy to the material.

To enable movement, the first and second energy beam sources 70 and 74 are attached to energy beam source movement actuators 72 and 76. The first and second energy beam sources 70, 74 may be a laser beam, an electron beam, a plasma beam, one or more circular laser beams, a scanned laser beam (scanned one, two or three dimensionally), an integrated laser beam, a pulsed (versus continuous wave) laser beam, etc. The use of a rectangular shaped beam may be advantageous for embodiments having a relatively large volume of particles to be heated. In such cases the first and/or second energy beam source 70, 74 may be a diode laser beam having a generally rectangular cross-sectional shape, although other known types of energy beams may also be used.

In some embodiments the first and second energy beam source 70, 74 may be in the form of lower power lasers (e.g., 503 nm and 1.06 μm Nd:YAG lasers) and/or higher power lasers (e.g., 1.06 μm ytterbium fiber, 5.4 μm CO and 10.6 μm CO₂ lasers). In some embodiments the intensity and shape of an energy beam may be precisely controlled by employing laser scanning (rastering) optics to form a heated area having a precisely defined size and shape to accommodate the shape of the sets of levitated particles being laser processed.

The components of the apparatus 50 are independently operable and may be directed by a controller 80 based in part upon optical signals inputted 82 from an optical instrument 78 to produce output 84 to the components.

FIG. 5 illustrates a related embodiment of an acoustic levitation laser processing apparatus 86 have a vertical orientation. This apparatus 86 contains all of the same components as the apparatus 50 of FIG. 4, but the orientation of the working area defined by the mutually-opposed phased-array ultrasonic transducers 20A-20B and 20C-20D (transducer 20D is not shown) are reversed such that the transducers 20A and 20B are arranged vertically and the particle handling device 66 is arranged horizontally. The embodiment of FIG. 5 can be useful in certain manufacturing and repair scenarios in which it is advantageous to dispose a component being fabricated or repaired in a horizontal orientation.

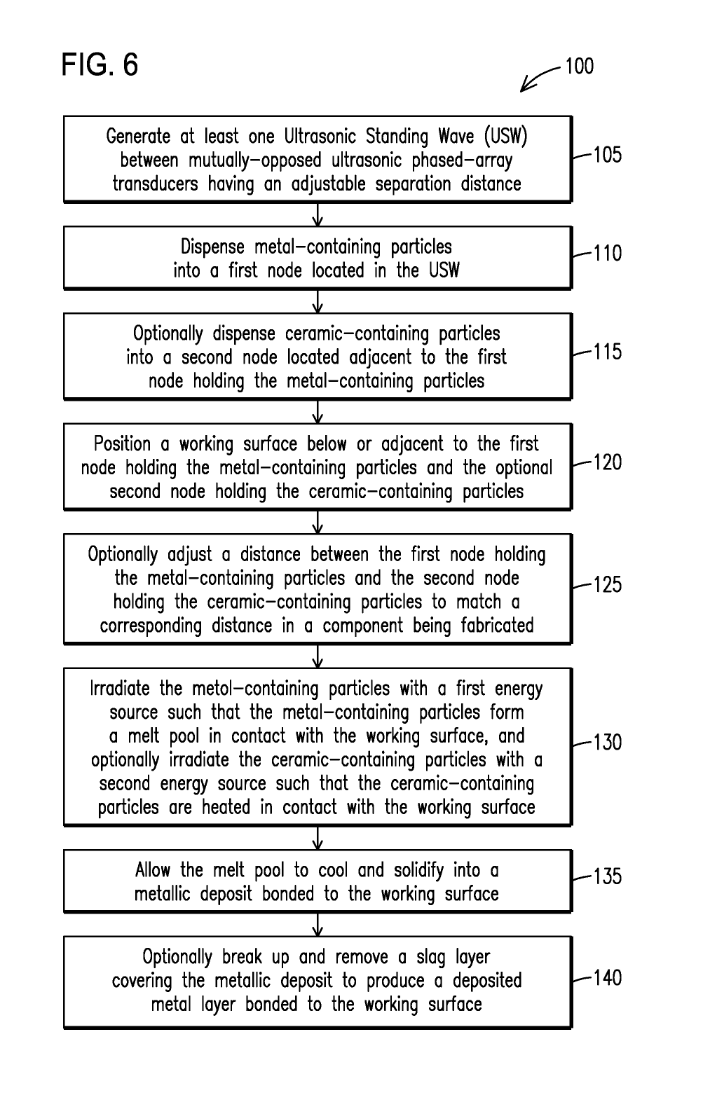

FIG. 6 is a schematic diagram of one embodiment of a method 100 for laser processing of particles being held and manipulated with acoustic energy using an apparatus such as those illustrated in FIGS. 4 and 5. In this method, step 105 involves generating at least one ultrasonic standing wave between mutually-opposed ultrasonic phased-array transducers having an adjustable separation distance. Step 110 involves dispensing metal-containing particles into a first node located in the ultrasonic standing wave. Optional step 115 involves dispensing ceramic-containing particles into a second node located adjacent to the first node holding the metal-containing particles. Step 120 involves positioning a working surface below or adjacent to the first node holding the metal-containing particles and optionally below or adjacent to the second node holding the optional ceramic-containing particles. Optional step 125 involves adjusting a distance between the first node holding the metal-containing particles and the second node holding the ceramic-containing particles to match a corresponding distance in a component being fabricated.

Step 130 involves irradiating the metal-containing particles with a first energy source such that the metal-containing particles form a melt pool in contact with the working surface, and optionally irradiating the optional ceramic-containing particles with a second energy source such that the ceramic-containing particles are heated in contact with the working surface. Step 135 involves allowing the melt pool to cool and solidify into a metallic deposit bonded to the working surface. Optional step 140 involves breaking up and removing an optional slag layer covering the metallic deposit to produce a deposited metal layer bonded to the working surface.

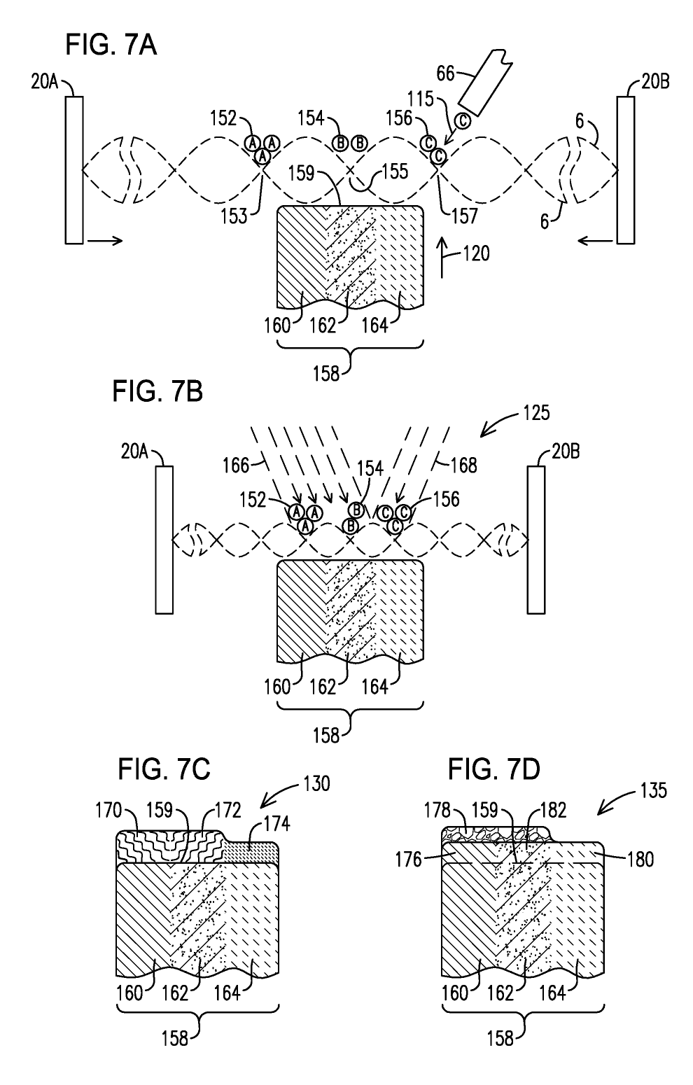

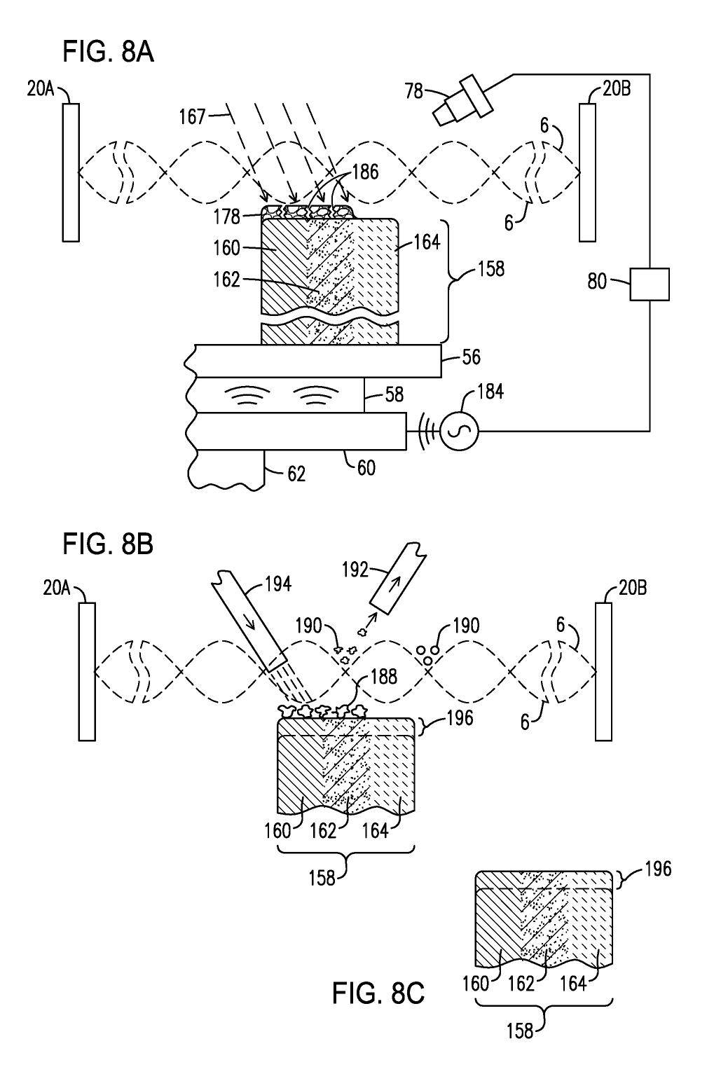

FIGS. 7A-7D and 8A-8C illustrate the processing steps of FIG. 6. As shown in FIG. 7A, steps 105, 110, 115 and 120 involve generating an ultrasonic standing wave 6 between mutually-opposed ultrasonic phased-array transducers 20A and 20B, dispensing metal-containing particles 154 into a first node 155 located in the ultrasonic standing wave, optionally dispensing ceramic-containing particles 156 into a second node 157 located adjacent to the first node 155 holding the metal-containing particles, and positioning 120 a working surface 159 below the first and second nodes 155, 157. FIG. 7A also shows an additional step of dispensing different metal-containing particles 152 into a third node 153 of the ultrasonic standing wave.

In some embodiments involving the dispensing of three different types of particles, for example, the metal-containing particles 152 may contain a superalloy metal, or elements of a superalloy metal, which ultimately form a superalloy substrate 160 of a component 158 being fabricated by the method 100—while the metal-containing particles 154 may contain a bond coat metal such as a MCrAlY, and the ceramic-containing particles 156 may contain a yttrium-stabilized zirconia (YSZ) which ultimately form a bond coat layer 162 and thermal barrier coating (TBC) 164 respectively of the component being fabricated.

The term “superalloy” is used herein as it is commonly used in the art, i.e., a highly corrosion and oxidation resistant alloy that exhibits excellent mechanical strength and resistance to creep at high temperatures. Superalloys typically include a high nickel or cobalt content. Examples of superalloys include alloys sold under the trademarks and brand names Hastelloy, Inconel alloys (e.g. IN 100, IN 700, IN 713, IN 738, IN 792, IN 939), Rene alloys (e.g. Rene N5, Rene 41, Rene 80, Rene 108, Rene 142, Rene 220), Haynes alloys (282), Mar M, CM 247, CM 247 LC, C263, 718, X-750, ECY 768, 282, X45, PWA 1480, PWA 1483, PWA 1484, CMSX single crystal alloys (e.g., CMSX-4, CMSX-8, CMSX-10), GTD 111, GTD 222, MGA 1400, MGA 2400, PSM 116, Mar-M-200, Udimet 600, Udimet 500 and titanium aluminide. The terms “metal,” “metallic material,” “alloy,” and “metal alloy” are used herein in a general sense to describe pure metals, semi-pure metals and metal alloys.

FIG. 7B illustrates the optional step 125 of adjusting a distance between the first node 155 holding the metal-containing particles 154 and the second node 157 holding the ceramic-containing particles to match a corresponding distance of or in a component 158 being fabricated. FIGS. 7B and 7C also illustrate the step 130 of irradiating the metal-containing particles 152, 154 with a first energy beam 166 to form a melt pool 170, 172 in contact with the working surface 159, and irradiating the ceramic-containing particles 156 with a second energy beam 168 such that the ceramic-containing particles are heated (sintered) 174 in contact with the working surface 159.

FIG. 7D illustrates the result of step 135 in which the melt pools 170, 172 are allowed to cool and solidify into metallic deposits 176, 182 bonded to the working surface 159. Cooling of the melt pools 170, 172 may also result in the formation of a slag layer 178 covering the metallic deposits 176, 182, and cooling of the heating ceramic material 174 results in the formation of a deposited TBC layer 180 bonded to the working surface 159.

FIG. 8A illustrates the step 140 of breaking up 186 the slag layer 178. In some embodiments, such as the illustration of FIG. 8A, the slag layer 178 is broken up 186 by applying ultrasonic energy to the component 158 via a transducer 60 in acoustic communication with the component 158. The breaking up 186 process may be further enhanced by positioning the breaking up slag layer 178 in contact with the ultrasonic standing wave 6 and/or by applying an energy beam 167 to the slag layer 178. The breaking up 186 process may be directed using a controller 80, based upon input from an optical instrument 78, in which a wavelength (frequency) and/or intensity of ultrasonic energy transmitted from the transducer 60 may be altered through an ultrasonic wave generator 184.

In some embodiments the transducer 60 may used to create an ultrasonic standing wave between the working surface 159 and an ultrasonic phased-array transducer positioned opposite the working surface 159. Some such embodiments, for example, employ a modified version of the apparatus of FIG. 5 in which the working surface 54 (attached to the horizontally-disposed moveable support structure 51) and an ultrasonic phase-array transducer 20 are mutually opposed such that an ultrasonic standing wave may be created allowing particles trapped with nodes to be shifted towards the working surface 54 by modulating the phase of the ultrasonic standing wave. In other similar embodiments the working surface may serve as a reflector to maintain an ultrasonic standing wave generated by an opposed ultrasonic phased-array transducer, wherein the phase of the standing wave may be modulated to shift trapped particles towards the working surface 54.

FIG. 8B illustrates the removal step 140 in which broken up slag layer 188 present on the deposited surface 196 may be dislodged using gas emitted from a gas-flushing device 194 (depicted in FIG. 8B as a pipette). Slag particles 190 that become levitated in nodes of the ultrasonic standing wave may also be withdrawn from the standing wave using a particle withdrawal device 192 (employing, e.g., a vacuum) capable of precisely withdrawing particles from individual nodes. In some embodiments the particle withdrawal device 192 may be in the form of an acoustically-reflective or non-reflective pipette device.

FIG. 8C illustrates a resulting component 158 including a newly deposited slice 196 containing a superalloy substrate layer 160, a bond coat layer 162 and a thermal barrier coating layer 164 whose separation and placement was controlled by the separation and placement of the levitated particles 152, 154 and 156 in relation to the positioning of the working surface 159.

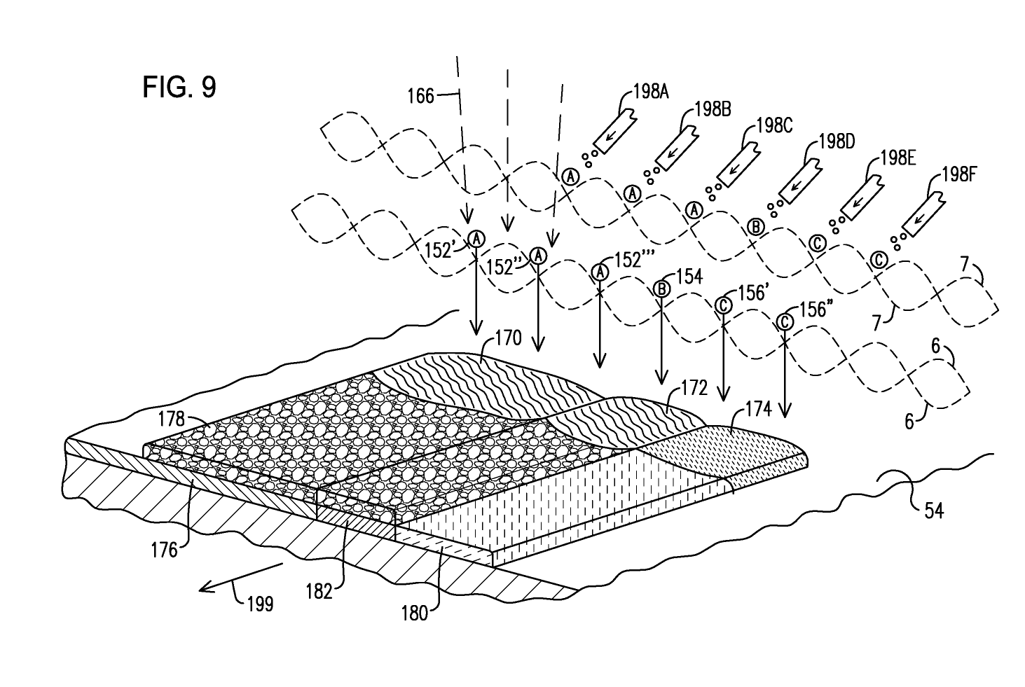

FIG. 9 illustrates one embodiment of a method for continuous laser processing of different sets of particles being independently held and manipulated with acoustic energy to form a multi-material deposit. In this non-limiting illustration, a series of powder deliver devices 198A-198F are used to dispense three sets of superalloy-containing particle sets 152′, 152″ and 152′″, one set of bond contain metal-containing particles 154, and two sets of TBC ceramic-containing particle sets 156′ and 156″ into multiple groups of linearly-situated situated nodes defined by ultrasonic standing waves 6 and 7. Laser processing using at least two different laser sources 166 (other sources not shown) leads to the formation of a superalloy-containing melt pool 170, a bond coat metal-containing melt pool 172, and a sintering ceramic deposit 174—all in contact with a working surface 54 which is continuously moved 199 such that a continuous layer of deposited superalloy 176, bond coat 182, and TBC 180 is bonded to the working surface 54. In some embodiments a slag layer 178 is also formed and covers the metallic deposits 176 and 182. After depositing a new slice 196 of component 158 under fabrication or repair, the slag layer 178 may be removed as explained above.

In some embodiments the working surface 54 in a process of FIG. 9 may be an upper surface of a multi-material component 158, such that the resulting deposited layer constitutes a slice 196 of a component being fabricated in an additive fashion. In other embodiments involving bulk production of metals, or involving the repair of hollow components, the working surface 54 may be in the form of fugitive support material. “Fugitive” means removable after formation of the cladding layer, for example, by direct (physical removal), by a mechanical process, by draining, by fluid flushing, by chemical leaching and/or by any other known process capable of removing the fugitive support material from its position. Examples of fugitive support materials include powders (e.g., metal, glass, ceramic, fiber powders), solid objects (e.g., metal, glass, ceramic, composite, plastic, resinous structures, graphite, dry ice), woolen materials (e.g., steel wool, aluminum oxide wool, zirconia wool) and foamed materials (e.g., polymer foams, high-temperature spray foams) to name a few. Any material or structure capable of providing support and then being removable after the formation of a metal and/or ceramic deposit may serve as the fugitive support material.

Another aspect of the present disclosure relates to embodiments which will enable the levitation and manipulation of metal-containing particles which are generally considered to be difficult, if not impossible, to levitate using acoustic energy. Whereas it is generally known that levitation of metal particles (such as traditionally-employed filler materials) can be very challenging due to the high density of such particles, the present invention will address this limitation by employing composite particles containing a metal alloy and a flux composition.

FIG. 10 illustrates a cross section of one embodiment of a composite material 88 in the form of coated particles comprising a flux-containing core 90 surrounded (coated) by a metallic layer 91. In this non-limiting illustration, the metallic layer 91 acts as a physical barrier that resists adsorption and permeation by atmospheric agents such as oxygen, nitrogen and moisture. In some embodiments the metallic layer 91 may also contain at least one metal (such as nickel) that is chemically resistant to atmospheric agents including oxygen and nitrogen.

The metallic layer 91 may contain a pure metal such as nickel, a metal alloy such as a superalloy, or combinations of different metals and alloys. Superalloys may contain mixtures of base metals (e.g., Ni, Fe and Co) along with other metals, metalloids and nonmetals such as chromium, molybdenum, tungsten, tantalum, aluminum, titanium, zirconium, niobium, rhenium, yttrium, vanadium, carbon, boron, and hafnium, to name a few. Examples of superalloys include alloys sold under the trademarks and brand names Hastelloy, Inconel alloys (e.g. IN 100, IN 700, IN 713, IN 738, IN 792, IN 939), Rene alloys (e.g. Rene N5, Rene 41, Rene 80, Rene 108, Rene 142, Rene 220), Haynes alloys (282), Mar M, CM 247, CM 247 LC, C263, 718, X-750, ECY 768, 282, X45, PWA 1480, PWA 1483, PWA 1484, CMSX single crystal alloys (e.g., CMSX-4, CMSX-8, CMSX-10), GTD 111, GTD 222, MGA 1400, MGA 2400, PSM 116, Mar-M-200, Udimet 600, Udimet 500 and titanium aluminide.

The metallic layer 91 may contain a metal content that matches the composition of a metallic deposit to be formed through melt processing, or it may contain a single metal or a subset of metals contained in the metallic deposit. Thus, as explained below in greater detail, a laser powder deposition using the composite particle 88 of FIG. 10 may be used to form a melt pool having a metal composition identical to the metallic layer 176, 182, or to form a melt pool whose metal composition is supplemented using at least one additional metal filler or metal-containing flux material.

The metallic layer 91 may be formed of a single metal layer having a homogeneous composition or may be formed of a single metal layer that is compositionally graded. In some embodiments, for instance, the metallic layer 91 of FIG. 10 may be graded such that the outer surface contains a higher proportion of nickel than the inner surface of the metallic layer 91—providing greater protection for reactive metals (e.g., Al, Ti and Fe) contained in the metallic layer 91. Upon melting, the metallic components of a compositionally-graded metallic layer 91 may then undergo mixing such that a resulting metal deposit is a homogeneous composition having a desired alloy content. The metallic layer 91 may also be formed of more than one metal layer having the same or different metallic compositions. By illustration, in some embodiments the composite particle 88 of FIG. 10 comprises a flux-containing core 90 surrounded (coated) by an intermediate superalloy layer which is surrounded (coated) by an outer layer of nickel.

As explained below in greater detail, the flux-containing core 90 comprises a flux composition providing at least one protective function during melt processing of composite particles. Flux compositions may include one or more inorganic compound such as a metal oxide, a metal halide, a metal oxometallate, a metal carbonate, or mixtures thereof, and may also include one or more organic compound such as a high-molecular weight hydrocarbon, a carbohydrate, a natural or synthetic oil, an organic reducing agent, a carboxylic acid or polyacid, a carboxylic acid salt or derivative, an amine, an alcohol, a natural or synthetic resin, or mixtures of such compounds, to name a few.

In some embodiments the composite particle 88 may also include an additional outer-protective layer (not shown) containing an inorganic protective material, which surrounds (coats) the metallic layer 91. Such inorganic protective materials may include metal oxides like alumina (Al₂O₃) and silica (SiO₂) that can protect the metallic layer 91 during storage and may also act as protective flux materials during laser processing. It is most useful if such inorganic outer protective layer is introduced as a smooth (e.g. glass-like) coating on the particles such that the surfaces are not hygroscopic.

Composite materials, such as the composite material 88 of FIG. 10, are expected to reduce physical and chemical defects in the corresponding melt processed materials—because the metallic layer 91 can contain chemically-resistant metals such as nickel which are inert to atmospheric reactants, and can also be surface processed to resist adsorption of atmospheric moisture.

Metal-coated composite materials such as the embodiment of FIG. 10 may be prepared using a variety of different methods depending upon the desired composition, size and geometry. Such methods include hydrometallurgical processing, physical and chemical vapor deposition, electroless plating, and gas-phase coating.

In some non-limiting processes a flux-containing particulate may be initially produced by agglomerating individual particles containing a flux composition using organic or inorganic binders, and then milling the resulting agglomerates to form a flux-binder mixture which is then cured to form flux-containing particles. The flux-containing particles may then be screened to a desired particle size, size range, or geometry required for a particular application. After the flux-containing particles are sized, a metal composition is deposited thereon to form coated composite materials such as the composite particle 88 of FIG. 10.

For example, the flux-containing particles may be clad with nickel using hydrometallurgical processing—in which a dissolved nickel complex is precipitated onto the flux-containing particles by reduction with hydrogen optionally at elevated temperature and pressure. After the nickel is precipitated onto the flux-containing particles, the resulting metal-coated composite particles may be washed and dried. Additional metal coating and/or alloying may also occur in order to produce multi-layered or graded coatings, or to modify the composition of the metallic layer, using processes such as chemical vapor deposition (CVD).

Physical vapor deposition (PVD) may also be used to form metal-coated composite materials such as the composite particle 88 of FIG. 10. In such processes a metallic material is vaporized and transported in the form of a vapor through a vacuum or low pressure gaseous environment (or plasma) to previously-sized flux-containing particles where the metallic material condenses. PVD processes may be used to deposit films of metal elements or alloys. For example, PVD may be used to coat flux-containing particles that are suspended in a fluidized bed by a fluidization gas. The PVD may be non-directed or directed which can provide metal-coated composite materials having defined and repeatable coatings. Directed vapor deposition (DVD) may also be used in combination with electron beam-based (or ion beam-based aka sputter deposition) evaporation techniques to improve the yield and/or quality of metal-coated composite materials suitable for melt processing. PVD can be used to generate single-layer metallic coatings as well as multi-layer and compositionally-graded coatings.

Electroless plating may also be used to produce metal-coated composite materials such as the composite particle 88 of FIG. 10. For example, an electroless plating solution containing a metal ion (such as nickel ion) and a soluble reducing agent (such as a hypophosphorate salt) may be mixed with flux-containing particles to form a metallic layer covering the flux-containing particles. Gas-phase coating may also be used by preparing a mixture of flux-containing particles in a flowable medium which is converted into an aerosol containing droplets of the flux-containing particles suspended in a carrier gas. The liquid contained in the aerosol may optionally be removed and the resulting gas-dispersed particles may optionally be dried by heating. The resulting gas-phase flux-containing particles may then be coated using, for example, physical vapor deposition (PVD) or chemical vapor deposition (CVD) with a reactive gas containing a metal such as nickel or a metal alloy.

Metal-coated composite materials, such as the composite particle 88 of FIG. 10, can be produced in various sizes ranging, for example, from about 1 to about 1000 micrometers in average diameter. In some embodiments the sizes range from about 5 to about 500 micrometers, or from about 20 to about 100 micrometers, in average diameter. Optimum ranges of size may vary according to application.

Importantly, both the size and the composition of composite materials suitable for acoustic handling and laser processing will be optimized to reduce density relative to traditional filler materials, while maintaining a large enough cross section (e.g., diameter) to maximize the acoustic forces applied to composite materials in contact with a standing ultrasonic wave. Such composite materials are formed such that a flux-to-metal volume ratio ranges from about 2:98 to about 98:2. Because flux compositions are generally less dense than metal alloys, higher flux-to-metal volume ratios tend to produce composite materials having lower overall density—which in some embodiments may be advantageous to ensure adequate acoustic trapping and manipulation. In some embodiments the flux-to-metal volume ratio ranges from about 40:60 to about 95:5, or from about 50:50 to about 85:15. In other embodiments the flux-to-metal volume ratio ranges from about 55:45 to about 90:10, or is about 65:35.

FIG. 11 illustrates another embodiment of a composite material 92 in the form of fused particles comprising a metal alloy 93 and a flux composition 94, wherein the metal alloy 93 and the flux composition 94 may be randomly distributed and randomly oriented within a fused composite lattice 95, or may be in a crystalline or semi-crystalline form. In the non-limiting illustration of FIG. 11, the fused structure of the composite material 92 acts as a physical or chemical barrier that resists adsorption and permeation by atmospheric agents such as oxygen, nitrogen and moisture. For example, the fused structure may be in the form of conglomerate flux/metal glass particles which exhibit high resistance to moisture adsorption and low reactivity with atmospheric reactants—unlike merely agglomerated flux/metal materials which are often very prone to moisture adsorption and air reactivity due to their relatively high surface area and porosity.

The metal or alloy 93 in the fused composite material 92 of FIG. 11 may be a pure metal such as nickel or may be metal alloys such as superalloys based on nickel, iron and cobalt, optionally containing other metals, metalloids and nonmetals as described above. The metallic portion of the composite material 92 may be in the form of equivalent metallic particles having the same composition, which are evenly distributed throughout the fused particles, or may in the form of non-equivalent metallic particles having different compositions. In one example of the later embodiments, the fused composite material 92 may contain non-equivalent metallic particles having different compositions which, when melted and mixed together into a melt pool, can form a superalloy metal deposit.

As explained below in greater detail, the flux composition 94 comprises a flux material providing at least one protective function during melt processing of the composite material 92. Flux compositions may include one or more inorganic compound such as a metal oxide, a metal halide, a metal oxometallate, a metal carbonate, or mixtures thereof, and may also include one or more organic compound such as a high-molecular weight hydrocarbon, a carbohydrate, a natural or synthetic oil, an organic reducing agent, a carboxylic acid or polyacid, a carboxylic acid salt or derivative, an amine, an alcohol, a natural or synthetic resin, or mixtures of such compounds, to name a few.

Fused composite materials, such as the composite material 92 of FIG. 11, are expected to reduce physical and chemical defects in the corresponding melt-processed materials—because the fused structure is in the form of a glass-like, crystalline, or semi-crystalline composite lattice that is highly resistant to both moisture adsorption and reactivity with atmospheric agents such as oxygen and nitrogen.

Fused composite materials such as the embodiment of FIG. 11 may be prepared by dry mixing the metal alloy 93 and the flux composition 94 together and then fusing or melting the resulting conglomerate mixture into a liquid state using, for example, a high-temperature furnace. The resulting molten material is then allowed to cool and solidify into a fused conglomerate glass, crystalline or non-crystalline form which may then be crushed or ground into different particle sizes and shapes.

Fused composite materials, such as the composite particle 92 of FIG. 11, can be produced in various sizes ranging, for example, from about 1 to about 1000 micrometers in average diameter. In some embodiments the sizes range from about 5 to about 500 micrometers, or from about 20 to about 100 micrometers, in average diameter.

Importantly, both the size and the composition of fused composite materials suitable for acoustic handling and laser processing will be optimized to reduce density relative to traditional filler materials while maintaining a large enough cross section (i.e., diameter) to maximize the acoustic forces applied to composite materials in contact with a standing ultrasonic wave. Such fused composite materials are formed such that a flux-to-metal volume ratio ranges from about 2:98 to about 98:2. Because flux compositions are generally less dense than metal alloys, higher flux-to-metal volume ratios tend to produce composite materials having lower overall density—which in some embodiments may be advantageous to ensure adequate acoustic trapping and manipulation. In some embodiments the flux-to-metal volume ratio ranges from about 40:60 to about 95:5, or from about 50:50 to about 85:15. In other embodiments the flux-to-metal volume ratio ranges from about 55:45 to about 90:10, or is about 65:35.

As explained and illustrated above, composite materials of the present disclosure (e.g., particles 88 and 92) contain both a metal portion and a flux composition which provides at least one protective function during melt processing. The flux composition and the resulting slag layer 178 (see FIGS. 7D and 9) can provide a number of beneficial functions that can improve the chemical and/or mechanical properties of deposited metals formed by melt processing of the composite materials described herein.

First, the flux composition and the resulting slag layer 178 can both function to shield both the region of the melt pool 170, 172 and the solidified (but still hot) melt-processed layer 176, 182 from the atmosphere. The slag floats to the surface to separate the molten or hot metal from the atmosphere, and the flux composition may be formulated to produce at least one shielding agent which generates at least one shielding gas upon exposure to laser photons or heating. In some embodiments shielding gases may coalesce into a gaseous envelope covering the melt pool 170, 172. Shielding agents include metal carbonates such as calcium carbonate (CaCO₃), aluminum carbonate (Al₂(CO₃)₃), dawsonite (NaAl(CO₃)(OH)₂), dolomite (CaMg(CO₃)₂), magnesium carbonate (MgCO₃), manganese carbonate (MnCO₃), cobalt carbonate (CoCO₃), nickel carbonate (NiCO₃), lanthanum carbonate (La₂(CO₃)₃) and other agents known to form shielding and/or reducing gases (e.g., CO, CO₂, H₂). The presence of the slag layer 178 and the optional shielding gas can avoid or minimize the need to conduct melt processing in the presence of inert gases (such as helium and argon) or within a sealed chamber (e.g., vacuum chamber or inert gas chamber) or using other specialized devices for excluding air.

Second, the slag layer 178 can act as an insulation layer that allows the resulting melt-processed layer 176, 182 to cool slowly and evenly, thereby reducing residual stresses that can contribute to post weld cracking, reheat or strain age cracking, and secondary reaction zone formation. Such slag blanketing over and adjacent to the deposited metal layer 176, 182 can further enhance heat conduction towards an underlying component, which in some embodiments can promote directional solidification to form elongated (uniaxial) grains in the melt-processed layer 176, 182.

Third, the slag layer 178 can help to shape and support the melt pool 170, 172 to keep them close to a desired height/width ratio (e.g., a ⅓ height/width ratio). This shape control and support further reduces solidification stresses that could otherwise be imparted to the melt-processed layer 176, 182. Along with shape and support, the slag layer 178 can also be produced from a flux composition that is formulated to enhance surface smoothness of the melt-processed layer 176, 182.

Fourth, the flux composition and the slag layer 178 can provide a cleansing effect for removing trace impurities that contribute to inferior properties. Such cleaning may include deoxidation of the melt pool 170, 172. Some flux compositions may also be formulated to contain at least one scavenging agent capable of removing unwanted impurities from the melt pool. Scavenging agents include metal oxides and fluorides [such as calcium oxide (CaO), calcium fluoride (CaF₂), iron oxide (FeO), magnesium oxide (MgO), manganese oxides (MnO, MnO₂), niobium oxides (NbO, NbO₂, Nb₂O₅), titanium oxide (TiO₂), zirconium oxide (ZrO₂), and other agents known to react with detrimental elements such as sulfur and phosphorous and elements known to produce low melting point eutectics] to form low-density byproducts expected to “float” into a resulting slag layer 178.

Fifth, the flux composition and the slag layer 178 can increase the proportion of thermal energy delivered to the working surface 54, 159 (see FIGS. 4-5, 7A and 9). This increase in heat absorption may occur due to the composition and/or form of the flux composition. In terms of composition the flux may be formulated to contain at least one compound capable of absorbing laser energy at the wavelength of a laser energy beam used as the energy beam 166. Increasing the proportion of a laser absorptive compound causes a corresponding increase in the amount of laser energy (as heat) applied to the particles. This increase in heat absorption can provide greater versatility by allowing the use of smaller and/or lower power laser sources that may be capable of producing a relatively shallower melt pool 170, 172. In some cases the laser absorptive compound could also be an exothermic compound that decomposes upon laser irradiation to release additional heat. An example of such composite exothermic particulate would be particles with a CO₂ generating core (e.g. including a carbonate) surrounded by aluminum and finally coated with nickel. Nickel coated aluminum powder is in fact proposed as a fuel for propulsion on Mars where CO₂ is plentiful and which provides for such exothermic reaction.

Additionally, the flux composition may be formulated to compensate for loss of volatilized or reacted elements during processing or to actively contribute elements to the melt-processed layer 176, 182 that are not otherwise contained in metal alloy 91, 93. Such vectoring agents include titanium, zirconium, boron and aluminum containing compounds and materials such as titanium alloys (Ti), titanium oxide (TiO₂), titanite (CaTiSiO₅), aluminum alloys (Al), aluminum carbonate (Al₂(CO₃)₃), dawsonite (NaAl(CO₃)(OH)₂), borate minerals (e.g., kernite, borax, ulexite, colemanite), nickel titanium alloys (e.g., Nitinol), niobium oxides (NbO, NbO₂, Nb₂O₅) and other metal-containing compounds and materials used to supplement molten alloys with elements. Certain oxometallates as described below can also be useful as vectoring agents.

In some embodiments the metal-containing particles 152, 154 may not be composite particles but may instead be typical metallic filler materials known in the relevant art. Furthermore, in some embodiments the ceramic-containing particles 156 may also contain a flux composition.

Flux compositions contained in particles of the present disclosure may include one or more inorganic compound selected from metal oxides, metal halides, metal oxometallates and metal carbonates. Such compounds may function as (i) optically transmissive vehicles; (ii) viscosity/fluidity enhancers; (iii) shielding agents; (iv) scavenging agents; and/or (v) vectoring agents.

Suitable metal oxides include compounds such as Li₂O, BeO, B₂O₃, B₅O, MgO, Al₂O₃, SiO₂, CaO, Sc₂O₃, TiO, TiO₂, Ti₂O₃, VO, V₂O₃, V₂O₄, V₂O₅, Cr₂O₃, CrO₃, MnO, MnO₂, Mn₂O₃, Mn₃O₄, FeO, Fe₂O₃, Fe₃O₄, CoO, Co₃O₄, NiO, Ni₂O₃, Cu₂O, CuO, ZnO, Ga₂O₃, GeO₂, As₂O₃, Rb₂O, SrO, Y₂O₃, ZrO₂, NiO, NiO₂, Ni₂O₅, MoO₃, MoO₂, RuO₂, Rh₂O₃, RhO₂, PdO, Ag₂O, CdO, In₂O₃, SnO, SnO₂, Sb₂O₃, TeO₂, TeO₃, Cs₂O, BaO, HfO₂, Ta₂O₅, WO₂, WO₃, ReO₃, Re₂O₇, PtO₂, Au₂O₃, La₂O₃, CeO₂, Ce₂O₃, and mixtures thereof, to name a few.

Suitable metal halides include compounds such as LiF, LiCl, LiBr, LiI, Li₂NiBr₄, Li₂CuCl₄, LiAsF₆, LiPF₆, LiAlCl₄, LiGaCl₄, Li₂PdCl₄, NaF, NaCl, NaBr, Na₃AlF₆, NaSbF₆, NaAsF₆, NaAuBr₄, NaAICl₄, Na₂PdCl₄, Na₂PtCl₄, MgF₂, MgCl₂, MgBr₂, AlF₃, KCl, KF, KBr, K₂RuCl₅, K₂IrCl₆, K₂PtCl₆, K₂PtCl₆, K₂ReCl₆, K₃RhCl₆, KSbF₆, KAsF₆, K₂NiF₆, K₂TiF₆, K₂ZrF₆, K₂PtI₆, KAuBr₄, K₂PdBr₄, K₂PdCl₄, CaF₂, CaF, CaBr₂, CaCl₂, CaI₂, ScBr₃, ScCl₃, ScF₃, ScI₃, TiF₃, VCl₂, VCl₃, CrCl₃, CrBr₃, CrCl₂, CrF₂, MnCl₂, MnBr₂, MnF₂, MnF₃, MnI₂, FeBr₂, FeBr₃, FeCl₂, FeCl₃, FeI₂, CoBr₂, CoCl₂, CoF₃, CoF₂, CoI₂, NiBr₂, NiCl₂, NiF₂, NiI₂, CuBr, CuBr₂, CuCl, CuCl₂, CuF₂, CuI, ZnF₂, ZnBr₂, ZnCl₂, ZnI₂, GaBr₃, Ga₂Cl₄, GaCl₃, GaF₃, GaI₃, GaBr₂, GeBr₂, GeI₂, GeI₄, RbBr, RbCl, RbF, RbI, SrBr₂, SrCl₂, SrF₂, SrI₂, YCl₃, YF₃, YI₃, YBr₃, ZrBr₄, ZrCl₄, ZrI₂, YBr, ZrBr₄, ZrCl₄, ZrF₄, ZrI₄, NbCl₅, NbF₅, MoCl₃, MoCl₅, RuI₃, RhCl₃, PdBr₂, PdCl₂, PdI₂, AgCl, AgF, AgF₂, AgSbF₆, AgI, CdBr₂, CdCl₂, CdI₂, InBr, InBr₃, InCl, InCl₂, InCl₃, InF₃, InI, InI₃, SnBr₂, SnCl₂, SnI₂, SnI₄, SnCl₃, SbF₃, SbI₃, CsBr, CsCl, CsF, CsI, BaCl₂, BaF₂, BaI₂, BaCoF₄, BaNiF₄, HfCl₄, HfF₄, TaCl₆, TaF₅, WCl₄, WCl₆, ReCl₃, ReCl₆, IrCl₃, PtBr₂, PtCl₂, AuBr₃, AuCl, AuCl₃, AuI, KAuCl₄, LaBr₃, LaCl₃, LaF₃, LaIₐ, CeBr₃, CeCl₃, CeF₃, CeF₄, CeI₃, and mixtures thereof, to name a few.

Suitable oxometallates include compounds such as LiIO₃, LiBO₂, Li₂SiO₃, LiClO₄, Na₂B₄O₇, NaBO₃, Na₂SiO₃, NaVO₃, Na₂MoO₄, Na₂SeO₄, Na₂SeO₃, Na₂TeO₃, K₂SiO₃, K₂CrO₄, K₂Cr2O₇, CaSiO₃, BaMnO₄, and mixtures thereof, to name a few.

Suitable metal carbonates include compounds such as Li₂CO₃, Na₂CO₃, NaHCO₃, MgCO₃, K₂CO₃, CaCO₃, Cr₂(CO₃)₃, MnCO₃, CoCO₃, NiCO₃, CuCO₃, Rb₂CO₃, SrCO₃, Y₂(CO3)₃, Ag₂CO₃, CdCO₃, In₂(CO₃)₃, Sb₂(CO₃)₃, O₂CO₃, BaCO₃, La₂(CO₃)₃, Ce₂(CO₃)₃, NaAl(CO₃) (OH)₂, and mixtures thereof, to name a few.

Optically transmissive vehicles include metal oxides, metal salts and metal silicates such as alumina (Al₂O₃), silica (SiO₂), zirconium oxide (ZrO₂), sodium silicate (Na₂SiO₃), potassium silicate (K₂SiO₃), and other compounds capable of optically transmitting laser energy (e.g., as generated from NdYAG, CO₂ and Yt fiber lasers).

Viscosity/fluidity enhancers include metal fluorides such as calcium fluoride (CaF₂), cryolite (Na₃AlF₆) and other agents known to enhance viscosity and/or fluidity (e.g., reduced viscosity with CaO, MgO, Na₂O, K₂O and increasing viscosity with Al₂O₃ and TiO₂) in welding applications.

Shielding agents include metal carbonates such as calcium carbonate (CaCO₃), aluminum carbonate (Al₂(CO₃)₃), dawsonite (NaAl(CO₃)(OH)₂), dolomite (CaMg(CO₃)₂), magnesium carbonate (MgCO₃), manganese carbonate (MnCO₃), cobalt carbonate (CoCO₃), nickel carbonate (NiCO₃), lanthanum carbonate (La₂(CO3)₃) and other agents known to form shielding and/or reducing gases (e.g., CO, CO₂, H₂).

Scavenging agents include metal oxides and fluorides such as calcium oxide (CaO), calcium fluoride (CaF₂), iron oxide (FeO), magnesium oxide (MgO), manganese oxides (MnO, MnO₂), niobium oxides (NbO, NbO₂, Nb₂O₅), titanium oxide (TiO₂), zirconium oxide (ZrO₂) and other agents known to react with detrimental elements such as sulfur and phosphorous to form low-density byproducts expected to “float” into a resulting slag layer 34.

Vectoring agents include titanium, zirconium, boron and aluminum containing compounds and materials such as titanium alloys (Ti), titanium oxide (TiO₂), titanite (CaTiSiO₅), aluminum alloys (Al), aluminum carbonate (Al₂(CO₃)₃), dawsonite (NaAl(CO₃)(OH)₂), borate minerals (e.g., kernite, borax, ulexite, colemanite), nickel titanium alloys (e.g., Nitinol), niobium oxides (NbO, NbO₂, Nb₂O₅) and other metal-containing compounds and materials used to supplement molten alloys with elements.

In some embodiments the flux composition may also contain certain organic fluxing agents. Examples of organic compounds exhibiting flux characteristics include high-molecular weight hydrocarbons (e.g., beeswax, paraffin), carbohydrates (e.g., cellulose), natural and synthetic oils (e.g., palm oil), organic reducing agents (e.g., charcoal, coke), carboxylic acids and dicarboxylic acids (e.g., abietic acid, isopimaric acid, neoabietic acid, dehydroabietic acid, rosins), carboxylic acid salts (e.g., rosin salts), carboxylic acid derivatives (e.g., dehydro-abietylamine), amines (e.g., triethanolamine), alcohols (e.g., high polyglycols, glycerols), natural and synthetic resins (e.g., polyol esters of fatty acids), mixtures of such compounds, and other organic compounds.

In some embodiments flux compositions include:

5-60% by weight of metal oxide(s);

10-70% by weight of metal fluoride(s);

5-40% by weight of metal silicate(s); and

0-40% by weight of metal carbonate(s),

based on a total weight of the flux composition.

In some embodiments flux compositions include:

5-40% by weight of Al₂O₃, SiO₂, and/or ZrO₂;

10-50% by weight of metal fluoride(s);

5-40% by weight of metal silicate(s);

0-40% by weight of metal carbonate(s); and

15-30% by weight of other metal oxide(s),

based on a total weight of the flux composition.

In some embodiments flux compositions include:

5-60% by weight of at least one of Al₂O₃, SiO₂, Na₂SiO₃ and K₂SiO₃;

10-50% by weight of at least one of CaF₂, Na₃AlF₆, Na₂O and K₂O;

1-30% by weight of at least one of CaCO₃, Al₂(CO₃)₃, NaAl(CO₃)(OH)₂, CaMg(CO₃)₂, MgCO₃, MnCO₃, CoCO₃, NiCO₃ and La₂(CO₃)₃;

15-30% by weight of at least one of CaO, MgO, MnO, ZrO₂ and TiO₂; and

0-5% by weight of at least one of a Ti metal, an Al metal and CaTiSiO₅, based on a total weight of the flux composition.

In some embodiments the flux compositions include:

5-40% by weight of Al₂O₃;

10-50% by weight of CaF₂,

5-30% by weight of SiO₂;

1-30% by weight of at least one of CaCO₃, MgCO₃ and MnCO₃;

15-30% by weight of at least two of CaO, MgO, MnO, ZrO₂ and TiO₂; and

0-5% by weight of at least one of Ti, Al, CaTiSiO₅, Al₂(CO₃)₃ and NaAl(CO₃)(OH)₂,

based on a total weight of the flux composition.

In some embodiments the flux composition contains at least two compounds selected from a metal oxide, a metal halide, an oxometallate and a metal carbonate. In other embodiments the flux composition contains at least three of a metal oxide, a metal halide, an oxometallate and a metal carbonate. In still other embodiments the flux composition may contain a metal oxide, a metal halide, an oxometallate and a metal carbonate. Viscosity of the molten slag may be increased by including at least one high melting-point metal oxide which can act as thickening agent. Thus, in some embodiments the flux composition is formulated to include at least one high melting-point metal oxide. Examples of high melting-point metal oxides include metal oxides having a melting point exceeding 2000° C.—such as Sc₂O₃, Cr₂O₃, Y₂O₃, ZrO₂, HfO₂, La₂O₃, Ce₂O₃, Al₂O₃ and CeO₂.

In some embodiments the flux compositions of the present disclosure include zirconia (ZrO₂) and at least one metal silicate, metal fluoride, metal carbonate, metal oxide (other than zirconia), or mixtures thereof. In such cases the content of zirconia is often greater than about 7.5 percent by weight, and often less than about 25 percent by weight. In other cases the content of zirconia is greater than about 10 percent by weight and less than 20 percent by weight. In still other cases the content of zirconia is greater than about 3.5 percent by weight, and less than about 15 percent by weight. In still other cases the content of zirconia is between about 8 percent by weight and about 12 percent by weight.

In some embodiments the flux compositions of the present disclosure include a metal carbide and at least one metal oxide, metal silicate, metal fluoride, metal carbonate, or mixtures thereof. In such cases the content of the metal carbide is less than about 10 percent by weight. In other cases the content of the metal carbide is equal to or greater than about 0.001 percent by weight and less than about 5 percent by weight. In still other cases the content of the metal carbide is greater than about 0.01 percent by weight and less than about 2 percent by weight. In still other cases the content of the metal carbide is between about 0.1 percent and about 3 percent by weight.

In some embodiments the flux compositions of the present disclosure include at least two metal carbonates and at least one metal oxide, metal silicate, metal fluoride, or mixtures thereof. For example, in some instances the flux compositions include calcium carbonate (for phosphorous control) and at least one of magnesium carbonate and manganese carbonate (for sulfur control). In other cases the flux compositions include calcium carbonate, magnesium carbonate and manganese carbonate. Some flux compositions comprise a ternary mixture of calcium carbonate, magnesium carbonate and manganese carbonate such that a proportion of the ternary mixture is equal to or less than 30% by weight relative to a total weight of the flux material. A combination of such carbonates (binary or ternary) is beneficial in most effectively scavenging multiple tramp elements.

Flux compositions of the present disclosure may be formulated to react chemically with the constituents of the melt pool 170, 172 in order to affect the mechanical properties of the resulting layer of slag 178 which can facilitate its removal. For example, it may be desirable to incorporate particularly brittle oxides into the slag layer 178. Slag detachability is a function of both the physical properties of the coating materials and the flux materials, as well as chemical reactions that can occur in the transitory melt. For example, large differences in coefficients of thermal expansion between the layer of slag 178 and underlying materials can promote effective detachment of the slag. The thickness of the resulting layer of slag 178 can also affect cooling rates and slag detachability as explained above. High cooling rates promote slags that are generally more difficult to remove.

Flux compositions rich in zirconia (ZrO₂) and/or alumina (Al₂O₃) may provide good slag detachability in processes of the present disclosure. In some embodiments described below, zirconia and/or alumina are contained as the majority component(s) in both the flux compositions and the resulting layers of slag 178. Rutile (TiO₂) containing fluxes can also produce slag layers 178 having good detachability. Similar benefits may also occur using titanium-containing oxometallates such as Cr₂TiO₅ and FeTiO₅. In some embodiments the flux composition contains an amount of rutile (TiO₂) ranging from about 2 percent by weight to about 10 percent by weight. In other embodiments flux compositions contains an amount of a titanium-containing oxometallate (e.g., Cr₂TiO₅, FeTiO₅, etc.) ranging from about 2 percent by weight to about 10 percent by weight.

For some alloy systems the presence of belite ((CaO)₂(SiO₂) or Ca₂SiO₄) in the flux composition can be beneficial to promote detachment of the slag layer 178; however, interactions with other compounds should also be considered. For example, the present inventors have found that the presence of CaF₂ in some flux compositions may be important in promoting fluidity of the molten slag and in reducing oxygen—but the presence of CaF₂ in flux compositions containing significant quantities of silica (or silica-type compounds) may produce a slag layer 178 that is difficult to remove. Consequently, flux compositions high in CaF₂ (e.g., at least 30 weight percent) and low in silica (SiO₂) (e.g., less than 10 weight percent) are found to be useful to form a more readily-detachable slag layer 178. Also, flux compositions containing lower CaF₂ contents (e.g., less than 25 weight percent) can tolerate higher levels of silica (SiO₂) (e.g., more than 15 weight percent) and still form a detachable slag layer 178. It is also recognized (as disclosed in U.S. Pat. No. 4,750,948 for submerged arc welding of nickel based alloys) that careful balancing of calcium fluoride, alumina, zirconia and cryolite (Na₃AlF₆) may be beneficial in producing good slag characteristics in embodiments of the present disclosure. Flux compositions of the present disclosure may contain modest amounts of CaO and MgO (esp., to provide cleansing action) but these compounds should be limited to avoid the formation of perovskite (CaTiO₃) and chromium spinel (MgAlCrO₄) that tend to adhere slag layers 178 to metal deposits 176, 182. Flux compositions of the present disclosure may include less than 20 percent by weight of CaO and MgO combined to provide some benefit without exhibiting an adverse effect on detachability. In some embodiments the flux compositions may include less than 10 percent by weight of CaO and MgO combined.

All of the percentages (%) by weight enumerated above are based upon a total weight of the flux material being 100%.

Commercially availed fluxes may also be used to form composite materials of the present disclosure. Examples includes flux materials sold under the names Lincolnweld P2007, Bohler Soudokay NiCrW-412, ESAB OK 10.16 and 10.90, Special Metals NT100, Oerlikon OP76, Bavaria WP 380, Sandvik 50SW, 59S or SAS1, and Avesta 805. Such commercial fluxes may be ground to a smaller particle size range before use. Such commercial fluxes may also be combined with other fluxing constituents mentioned above for enhanced purposes of fluidity control, scavenging, detachability, etc.

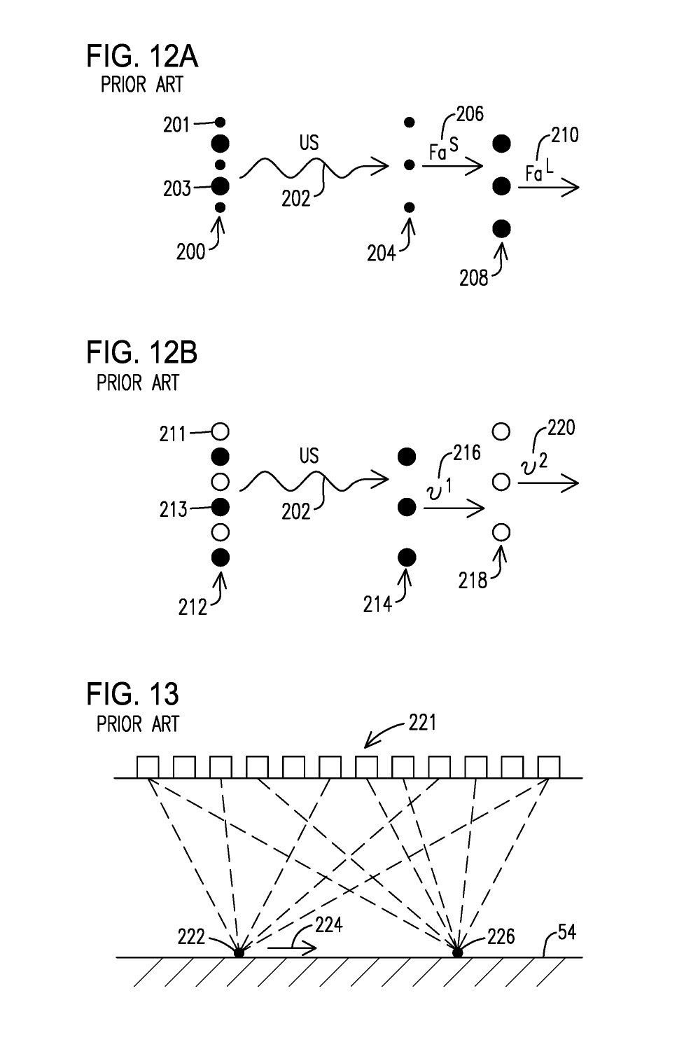

Other embodiments will enable the separation and laser processing of different particles using acoustic energy based on differences in particle size, shape and density. FIGS. 12A and 12B illustrate the use of acoustic energy to separate particles having different sizes and different densities. Focusing on FIG. 12A, it is known that particles exposed to acoustic energy may be subjected to different acoustic forces based on the cross section presented by the particles. In the illustration of FIG. 12A, a mixture 200 of two different kinds of particles having the same density—small particles 201 and large particles 203—may be subject to different forces. In most circumstances it is expected that the small particles 201 will experience a smaller acoustic force (Fₐ^{S}) 206 when exposed to ultrasound 202, and the larger particles 203 will experience a larger acoustic force (Fₐ^{L}) 210. Consequently, when directed to an ultrasonic focal point under the influence of the ultrasound 202, the small particles 201 will move at a lower velocity and the large particles 203 will move at a higher velocity—such that the small and large particles will separate to form separate groups of particles 204 (small particles) and 208 (large particles).

Particles may also be separated using acoustic energy based on differences in particle density. Focusing on FIG. 12B, it is known that particles exposed to acoustic energy may move at different velocities due to differences in particle density—leading to differences in particle acceleration. In the illustration of FIG. 12B, a mixture 212 of two different kinds of particles having the same cross section (size) but different densities—particles of lower density 211 and particles of higher density 213—may experience different accelerations. In most circumstances it is expected that particles having the same cross section (size) will experience the same acoustic force when exposed to ultrasound 202. Therefore, the resulting acoustic acceleration for each type of particle will be indirectly proportional to the density (and mass) of the particle—such that the higher density particles 213 will experience a lower acceleration and velocity (v¹) 216 and the lower density particles 211 will experience a higher acceleration and velocity (v²) 220. Consequently, when directed to an ultrasonic focal point under the influence of the ultrasound 202, the lower density particles 211 and the higher density particles 213 will separate to form separate groups of particles 218 (lower density particles) and 214 (higher density particles).

Embodiments of the present disclosure can utilize these acoustic phenomena to separate different types of particles on a working surface. FIG. 13 illustrates the use of an ultrasonic phase-array transducer to generate and move a single focal point from one location on a working surface 54 to another location. It is known to use ultrasonic phased-array transducers that can be tuned to steer particles to a certain focal point in a two or three-dimensional space. FIG. 13 illustrates one embodiment in which a linear ultrasonic phased-array transducer 221 is used to generate an initial focal point 222, which is then shifted 224 continuously from the initial focal point 222 to a final focal point 226 located some distance away on a working surface 54.

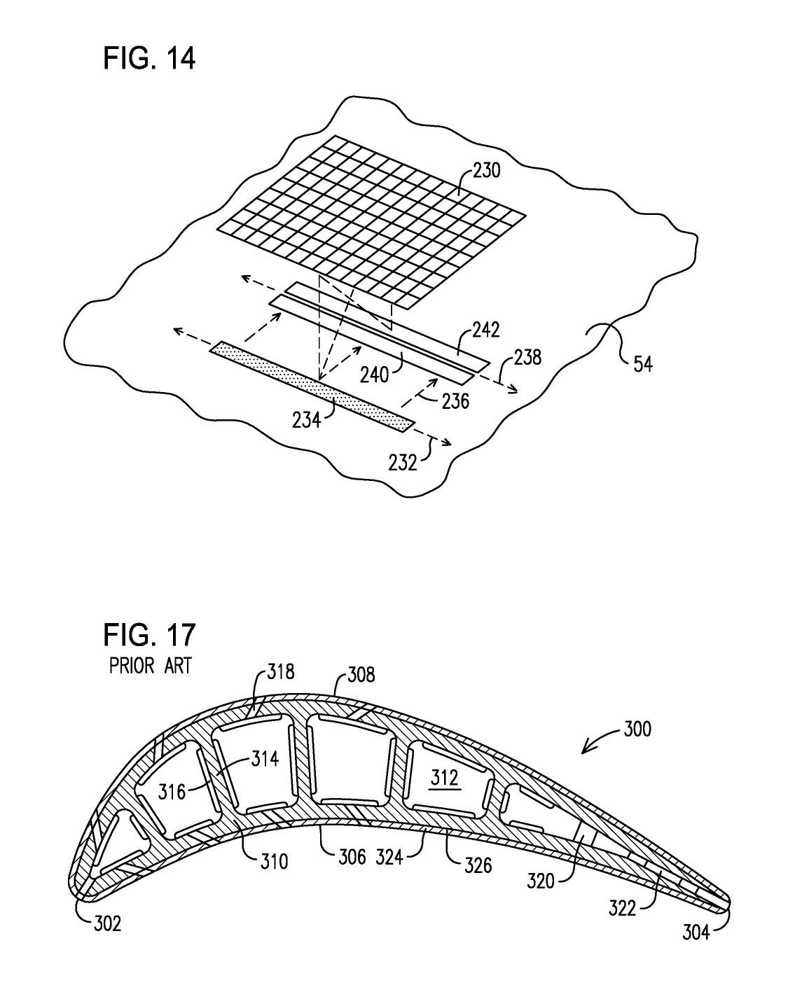

FIG. 14 illustrates one embodiment of a method for separating particles on a working surface 54 using acoustic energy. This non-limiting illustration employs a two-dimensional ultrasonic phase-array transducer 230 adapted to create an initial focal line 232 on the working surface 54. A mixture 234 of two different particle types arranged into a line (distinguished by cross section (size) or density) is then steered into the initial focal line 232 using ultrasonic irradiation. The mixture of particles may originate from an adjacent powder bed, or may originate from a particle delivery device as illustrated in FIGS. 4-5 and 7A and described above. The separation process occurs by continuously shifting 236 the focal line from the initial focal line 232 to a final focal line 238. As the particle mixture moves from the initial focal line 232 to the final focal line 238 the different types of particles can be separated based upon differences in cross section (size) or density as explained above to form two separate lines 240 and 242 containing the respective particle types. Laser processing may then be carried out to selectively heat or melt the respective particles lines to form metal deposits and ceramics, as illustrated in FIGS. 7A-D.

Other embodiments will enable the separation and laser processing of different particles using acoustic energy based on differences in the natural vibrational frequencies of the different particles. Both metallic and non-metallic particles held together by intra-particle bonds (e.g., covalent and non-covalent bonds) may be vibrated by exposure to radiation at one or more frequencies corresponding to resonance frequencies of the particles. These resonance frequencies (also commonly referred to as “natural” frequencies) depend upon both the strength (stiffness) of the intra-bonds and the mass of the intra-particle bodies (elements) held together by the intra-bonds, as expressed in Equation (2):

$${f}_{n} = \frac{1}{2 π} \sqrt{\frac{k}{m}} \qquad ( 2 )$$

where “k” represents the stiffness (strength) (N/m) of the intra-particle bond and “m” represents the mass (kg) of the intra-particle bodies (elements).

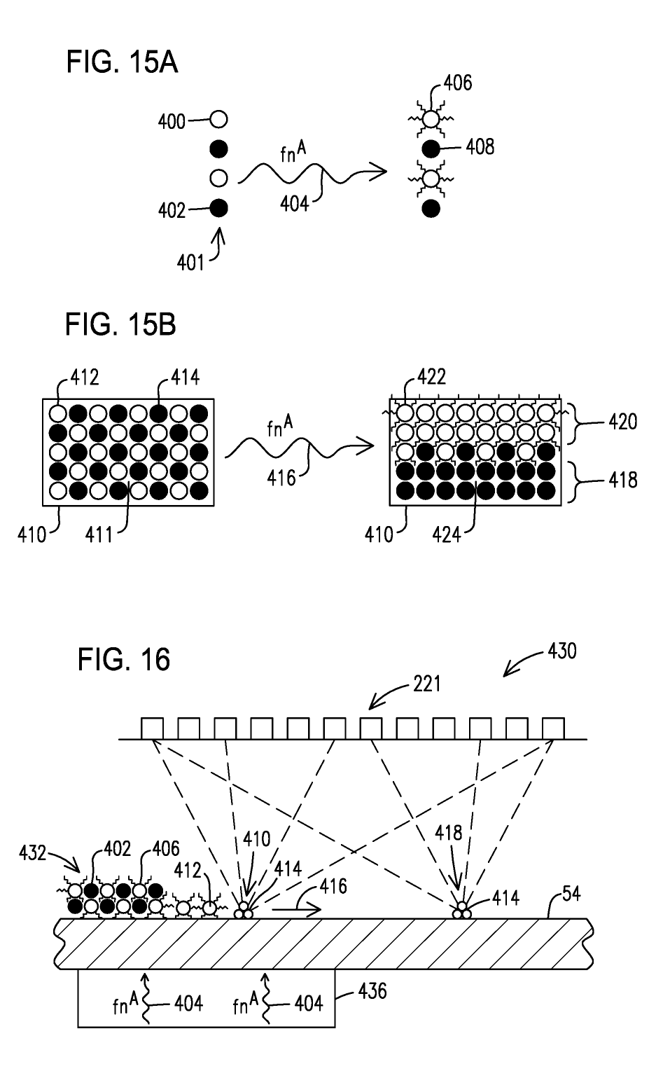

Because different particles will generally possess different natural vibrational frequencies, it is possible to selectively vibrate and translate particles by applying acoustic energy at a natural frequency of a certain type of particle. FIG. 15A illustrates the use of acoustic energy to selectively excite a particle A 400 having a natural frequency fₙ^{A}. FIG. 15A shows a group of particles 401 including particles A 400 having a certain natural frequency (fₙ^{A}) and particles B 402 having a different natural frequency (fₙ^{B}). Upon exposure of the group of particles 401 to acoustic energy 404 having the same frequency (fₙ^{A}) as the particles A 400, the particles A become vibrationally excited particles 406—whereas the particles B 302 remain in a non-excited (non-vibrating) state. Using this ability to selective excite and vibrate particles will enable these particles to be selectively manipulated as further explained below.

One type of selective particle manipulation using natural vibrational frequencies is illustrated in FIG. 15B. FIG. 15B shows the use of acoustic energy to selectively excite particles having a natural vibrational frequency (fₙ^{A}), causing a selective fluidization of particles in a mixed bed 410. The mixed bed 410 in this case includes particles A 412 having a certain natural frequency (fₙ^{A}) and particles B 414 having a different natural frequency (fₙ^{B}). Upon exposure of the mixed bed 410 to acoustic energy 416 having the same frequency (fₙ^{A}) as the particles A 412, the particles 412 become vibrationally excited particles 422—whereas the particles B 414 remain in a non-excited (non-vibrating) state. This selective excitation of the particles 422 causes a selective fluidization of the particles 422, allowing them to move in a certain direction (shown in this case moving in an upward direction) based on properties such as particle density—such that an initially uniform mixed bed 411 is transformed into a non-uniform mixed bed 424. In the resulting non-uniform mixed bed 424, the excited particles A 422 congregate primarily in an upper layer 420; whereas the non-excited particles 414 remain primarily in a lower layer 418. In this manner, by non-limiting example, particles having different natural vibrational frequencies may be selectively moved in a vertical direction.

Different particles may also be selectively excited and moved in a horizontal direction as illustrated in FIG. 16. FIG. 16 shows an apparatus capable of selectively exciting particles having a certain natural vibrational frequency (fₙ), and then using acoustic trapping and steering to further translate the excited particles along a horizontal working surface 54. This apparatus includes the working surface 54 upon which a mixture 432 of particles A 406 and particles B 402 is placed in acoustic communication with a transducer 436 adapted to apply acoustic energy a different (electronically-tunable) frequencies. The particles A 406 have a natural vibrational frequency (fₙ^{A}) that is different than the natural vibrational frequency (fₙ^{B}) of the particles B 402. Upon exposure of the mixture 432 to acoustic energy 404 having the same frequency as the natural vibrational frequency (fₙ^{A}) of the particles A 406, these particles become vibrationally excited and can move (spread) along the horizontal working surface.

The apparatus of FIG. 16 also includes an ultrasonic phased-array transducer 221 adapted to produce tunable acoustic focal points at various locations along the working surface 54. In the illustration of FIG. 16 the ultrasonic phased-array transducer 221 is initially tuned to create an initial focal point 410—causing some of the excited particles A 406 to move 412 into the focal point 410 and become acoustically trapped. Meanwhile, the non-excited particles B 402 remain largely unaffected in the mixture 432. Additional translation of the trapped particles 414 may then be accomplished by altering the tuning of the ultrasonic phased-array transducer 221 such that the focal point moves 416 from the initial focal point 410 to a final focal point 418. Such movement 416 of the focal point thereby selectively translates the trapped particles 414 to a new location on the working surface 54.

Embodiments such as the apparatus and method of FIG. 16 are expected to enable the selective manipulation and laser processing of both metallic and non-metallic particles, to produce multi-material articles through additive manufacturing.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method, comprising:
generating at least one ultrasonic standing wave between at least one set of mutually-opposed ultrasonic transducers;
dispensing metal-containing particles into a node located within the at least one ultrasonic standing wave, such that the metal-containing particles are trapped within the node;
positioning a surface of a substrate proximate to the node such that the metal-containing particles become or remain trapped within the node;
melting the metal-containing particles with an energy beam to form a melt pool in contact with the surface of the substrate; and
allowing the melt pool to cool and solidify into a metal deposit bound to the surface of the substrate.

2. The method of claim 1, comprising generating two orthogonally-arranged ultrasonic standing waves with two orthogonally-arranged sets of mutually-opposed ultrasonic transducers.

3. The method of claim 1, wherein a gaseous medium surrounds the trapped metal-containing particles such that the particles are levitated in a three-dimensional space defined in part by an arrangement of the at least one set of mutually-opposed ultrasonic transducers.

4. The method of claim 3, further comprising tuning the at least one set of transducers in order to change a position of the trapped metal-containing particles within the three-dimensional space.

5. The method of claim 1, wherein the metal-containing particles are composite particles comprising a metal alloy and a flux composition.

6. The method of claim 5, wherein the flux composition comprises a metal oxide and at least one selected from the group consisting of a metal halide, a metal oxometallate and a metal carbonate.

7. The method of claim 5, wherein the composite particles are in the form of particles comprising a core surrounded by a metallic layer, such that:
the core comprises the flux composition; and
the metallic layer comprises the metal alloy.

8. The method of claim 5, wherein the composite particles are in the form of a fused material comprising the metal alloy and the flux composition, such that the metal alloy and the flux composition are randomly distributed and randomly oriented within the fused material.

9. The method of claim 1, wherein the metal deposit is covered by a slag layer, and further comprising:
disintegrating the slag layer with acoustic energy; and
removing disintegrated slag materials from a surface of the metal deposit;
wherein the acoustic energy is transmitted to the slag layer through the substrate; and/or
the acoustic energy is transmitted to the slag layer from at least one of the ultrasonic transducers.

10. A method for making a component, the method comprising:
generating at least one ultrasonic standing wave between at least one set of mutually-opposed ultrasonic transducers;
dispensing metal-containing particles into a first node located within the at least one ultrasonic standing wave, such that the metal-containing particles are trapped within the first node;
dispensing ceramic-containing particles into a second node located adjacent to the first node, such that the ceramic-containing particles are trapped within the second node;
adjusting a distance between the first and second nodes such that a distance between trapped metal-containing particles and trapped ceramic-containing particles corresponds to respective area shapes representing respective final materials in a given section plane of a multi-material component;
positioning a working surface below or adjacent to the first and second nodes such that the metal-containing particles and the ceramic-containing particles become or remain trapped in the first and second nodes respectively, and such that a position of the metal-containing particles and the ceramic-containing particles corresponds to the respective area shapes;
melting the metal-containing particles with a first energy beam to form a melt pool in contact with the working surface;
heating the ceramic-containing particles with a second energy beam to form a heated ceramic material in contact with the working surface;
allowing the melt pool to cool and solidify into a metal deposit bound to the working surface;
allowing the heated ceramic material to cool into a ceramic deposit bound to the working surface; and
optionally moving the working surface and/or the at least one ultrasonic standing wave and repeating the above steps for successive section planes of the multi-material component to fabricate the multi-material component.

11. The method of claim 10, comprising generating two orthogonally-arranged ultrasonic standing waves with two orthogonally-arranged sets of mutually-opposed ultrasonic transducers.

12. The method of claim 10, wherein a gaseous medium surrounds the trapped metal-containing particles and the trapped ceramic-containing particles such that all particles are levitated in a three-dimensional space defined in part by an arrangement of the at least one set of mutually-opposed ultrasonic transducers.

13. The method of claim 12, further comprising tuning the at least one set of transducers in order to change a position of the trapped metal-containing particles and the trapped ceramic-containing particles within the three-dimensional space.

14. The method of claim 10, wherein the metal-containing particles are composite particles comprising a metal alloy and a flux composition.

15. The method of claim 14, wherein the composite particles are in the form of particles comprising a core surrounded by a metallic layer, such that:
the core comprises the flux composition; and
the metallic layer comprises the metal alloy.

16. The method of claim 14, wherein the composite particles are in the form of a fused material comprising the metal alloy and the flux composition, such that the metal alloy and the flux composition are randomly distributed and randomly oriented within the fused material.

17. The method of claim 10, wherein the metal deposit is covered by a slag layer.

18. The method of claim 17, further comprising:
disintegrating the slag layer with acoustic energy; and
removing disintegrated slag materials from a surface of the metal deposit;
wherein the acoustic energy is transmitted to the slag layer through the working surface; and/or
the acoustic energy is transmitted to the slag layer from at least one of the ultrasonic transducers.

19. A method, comprising:
generating at least one ultrasonic standing wave between a working surface and at least one ultrasonic transducer;
dispensing metal-containing particles into a node located within the at least one ultrasonic standing wave, such that the metal-containing particles are trapped within the node;
positioning the working surface proximate to the node such that the metal-containing particles become or remain trapped within the node;
optionally modulating a phase of the at least one ultrasonic standing wave in order to alter a position of the metal-containing particles trapped within the node;
melting the metal-containing particles with an energy beam to form a melt pool in contact with the working surface; and
allowing the melt pool to cool and solidify into a metal deposit bound to the working surface.

20. The method of claim 19, further comprising transmitting ultrasound from the working surface such that ultrasonic waves transmitted from the working surface and at least one ultrasonic transducer are in resonance to generate the ultrasonic standing wave between the working surface and the at least one ultrasonic transducer.
